(19) United States
(12) Patent Application Publication
(10) Pub. No.: US 2021/0339353 A1
(43) Pub. Date: Nov. 4, 2021

(54) METHOD OF DETECTING INTEGRITY INDEX OF MACHINE TOOL

(71) Applicant: ITS CO., LTD., Ulsan (KR)

(72) Inventor: Young Kyu Lee, Ulsan (KR)

(73) Assignee: ITS CO., LTD.

(21) Appl. No.: 17/353,599

(22) Filed: Jun. 21, 2021

Related U.S. Application Data
(63) Continuation of application No. PCT/KR2019/014522, filed on Oct. 31, 2019.

(30) Foreign Application Priority Data
Dec. 27, 2018 (KR) 10-2018-0171365

(51) Int. Cl. B23Q 17/09

(52) U.S. Cl. CPC B23Q 17/0995; B23Q 17/0957; B23Q 17/0961

(57) ABSTRACT

The method of the present invention includes: an integrity information collection step of collecting a current amount; a first inferiority information collection step of collecting a current amount; a setting step of setting an integrity reference value and an inferiority reference value on the basis of the information collected; an extraction step of collecting a current amount in real time, and extracting a measurement value from the collected information; a detection step of detecting an integrity index value of the machine tool by comparing the measurement value extracted with the integrity reference value and the inferiority reference value set in the setting step; and an outputting step of outputting the integrity index value detected.

### CROSS-REFERENCE TO RELATED APPLICATIONS

The present application is a bypass continuation application of currently pending international application No. PCT/KR2019/014522 having an international filing date of Oct. 31, 2019 and designating the United States, the international application claiming a priority date of Dec. 27, 2018 based upon prior filed K.R patent application No. 10-2018-0171365, the entire contents of the aforesaid international application and the aforesaid K.R. patent application being incorporated herein by reference.

### TECHNICAL FIELD

The present invention relates to a method of detecting an integrity index of a machine tool and, more particularly, to a method of detecting an integrity index of a machine tool, the method: collecting the information of power that is consumed by a machine with a machine tool in a normal state and the information of power that is consumed by the machine with the machine tool in a worn state: constructing an integrity index reference table on the basis of the collected information; applying measurement values collected in real time through the machine to the integrity index reference table; and outputting and providing in real time an integrity index value showing the integrity of the machine tool to a manager, thereby enabling the manager to clearly recognize the real-time integrity of a machine tool from an integrity index, to make a plan for examining or replacing the machine tool by himself/herself, and to very actively and stably manage the entire machine tool, and preventing a safety accident or an economic loss due to damage or breakage of the machine tool.

### BACKGROUND ART

In general, machines are equipment for machining workpieces and employ tools for machining workpieces.

Since the tools for workpieces are gradually worn when they are used, when the performance (function) is deteriorated after they are used for a predetermined period, they are replaced with new tools. In general, the tools are replaced in a prevention-preservation method that replaces a tool with a new tool after the tool is used only for a predetermined available period.

Accordingly, although a toll can be sufficiently used more, the tool is replaced in advance in consideration of a large economic loss that may be generated by possible damage or breakage of the tool, so there is a problem that the tool is not efficiently replaced and managed.

Accordingly, there is an urgent need for a method that can induce efficiently management of a tool by providing the information about the state of a machine tool to a manager such that the manager clearly recognizes the state of the tool in real time and sets periods for stable examination, repair, and replacement of the tool.

### DISCLOSURE

### Technical Problem

The present invention has been made in an effort to solve the problems and an object of the present invention is to provide a method of detecting an integrity index of a machine tool, the method: collecting information of power that is consumed by a machine when the machine tool is in a normal state and information of power that is consumed by the machine when the machine tool is in a worn state, constructing an integrity index reference table on the basis of the collected information, applying measurement values collected in real time through the machine to the integrity index reference table, and outputting and providing in real time an integrity index value showing the integrity of the machine tool to a manager, thereby enabling the manager to clearly recognize the real-time integrity of a machine tool from an integrity index, to make a plan for examining or replacing the machine tool by himself/herself, and to very actively and stably manage the entire machine tool, and preventing a safety accident or an economic loss due to damage or breakage of the machine tool.

Another object of the present invention is to provide a method of detecting an integrity index of a machine tool, the method being able to more precisely detect the integrity of a machine tool through the integrity index value by collecting the amount of current, which is consumed by a machine in accordance with lapse of time for each of an inflow period, a constant period, and an outflow period before a machine tool is broken; by setting a warning value and a critical value of each period on the basis of the collected information; by detecting the number of times that a current amount, which is consumed by the machine in real time, exceeds the warning value and the critical value of each period; and by subtracting the subtraction value corresponding to the detected number of times from an integrity value.

### Technical Solution

In order to achieve the objects, a method of detecting an integrity index of a machine tool according to the present invention includes: an integrity information collection step of collecting a current amount, which is consumed when a machine tool machines a workpiece in a normal state, in accordance with lapse of time; a first inferiority information collection step of collecting a current amount, which is consumed when the machine tool machines the workpiece in a worn state, in accordance with lapse of time; a setting step of setting an integrity reference value and an inferiority reference value on the basis of the information collected in the integrity information collection step and the first inferiority information collection step; an extraction step of collecting a current amount that is consumed when the workpiece is machined through the machine tool in real time in accordance with lapse of time, and extracting a measurement value from the collected information; a detection step of detecting an integrity index value of the machine tool by comparing the measurement value extracted in the extraction step with the integrity reference value and the inferiority reference value set in the setting step; and an outputting step of outputting and providing the integrity index value detected in the detection step to a manager.

The integrity reference value, the inferiority reference value, and the measurement value may be set as any one selected from a peak current value, an integration area value, and a machining interval value of the workpiece that may be extracted from a current amount according to lapse of time that is consumed by the machine when the workpiece is machined.

The detection step may include: a dividing process of dividing the period between the integrity reference value and the inferiority reference value set in the setting step into at least two periods; a setting process of constructing an integrity index reference table by setting the periods divided between the integrity reference value and the inferiority reference value as a first period, a second period, . . . , an n-th period sequentially from the integrity reference value and by setting an integrity index value for each of the periods; a detection process of detecting a period to which a measurement value corresponds by applying the measurement value extracted in the extraction step to the integrity index reference table, and of extracting the integrity index value of the detected period.

The method of detecting an integrity index of a machine tool according to the present invention may further include a second inferiority information collection step of collecting a current amount that is consumed in accordance with lapse of time when the machine machines the workpiece before the machine tool is broken for each of an inflow period, a constant period, and an outflow period.

The setting step may set a warning value and a critical value in each of the inflow period, the constant period, and the outflow period on the basis of the information collected in the second inferiority information collection step; the extraction step may collect in real time a current amount that is consumed when the workpiece is machined by the machine tool for each of the inflow period, the constant period, and the outflow period; and the detection step may detect an integrity index value of the machine tool by detecting the number of times that the current amount of the inflow period, the constant period, and the outflow period collected in the extraction step exceeds the warning value and the critical value in each of the inflow period, the constant period, and the outflow period set in the setting step.

The detection step may set a subtraction value for each of the warning value and the critical value, detect an integrity index value by applying the measurement value extracted in the extraction step to the integrity index reference table, and subtracting a subtraction value corresponding to the number of times of exceeding the warning value and the critical value from the detected integrity index value.

### Advantageous Effects

As described above, the method of detecting an integrity index of a machine tool: collects the information of power that is consumed by a machine with a machine tool in a normal state and the information of power that is consumed by the machine with the machine tool in a worn state: constructs an integrity index reference table on the basis of the collected information; applies measurement values collected in real time through the machine to the integrity index reference table; and outputs and providing in real time an integrity index value showing the integrity of the machine tool to a manager, thereby enabling the manager to clearly recognize the real-time integrity of a machine tool from an integrity index, to make a plan for examining or replacing the machine tool by himself/herself, and to very actively and stably manage the entire machine tool, and preventing a safety accident or an economic loss due to damage or breakage of the machine tool.

Further, the method: collects a current amount that is consumed by a machine in accordance with lapse of time before a machine tool is broken; sets a warning value and a critical value of each period on the basis of the collected information; detects in real time the number of times that the current amount consumed by the machine exceeds the warning value and the critical value of each period; and subtracts a subtraction value corresponding to the detected number of times from an integrity index value, thereby being able to more precisely detect the integrity of the machine tool through the integrity index value.

### DESCRIPTION OF DRAWINGS

FIG. 1 is a flowchart of a method of detecting an integrity index of a machine tool according to an embodiment of the present invention.

FIG. 2 shows a current amount (power information) according to time in a machine with a machine tool in a normal state.

FIG. 3 shows current amount information according to time in a machine with a machine tool in a worn state.

FIG. 4 shows a period divided between an integrity reference value and an inferiority reference value.

FIG. 5 shows the case in which the period between the integrity reference value and the inferiority reference value are divided into 10 periods.

FIG. 6 shows a process of extracting an integrity index value from a measurement value.

FIG. 7 shows a power consumption amount according to an inflow period, a constant period, and an outflow period.

FIG. 8 is a view showing a warning value and a critical value set in each of the inflow period, the constant period, and the outflow period.

FIG. 9 shows a process of detecting an integrity index value by applying the information of the number of times of exceeding the warning value and the critical value.

### BEST MODE

It should be noted that technical terms used in the specification are used only in order to describe specific exemplary embodiments rather than limiting the present invention. Further, the technical terms used herein should be construed as meanings that are generally understood by those skilled in the art unless specifically defined as other meanings herein and should not be construed as excessively comprehensive meanings or excessively reduced meanings. Further, when the technical terms used herein are wrong technical terms that do not exactly express the spirit of the present invention, they should be replaced with technical terms that can be understood right by those skilled in the art.

Further, general terms used herein should be construed on the basis of previous and following contexts in accordance with those defined in dictionaries and should not be construed as excessively reduced meanings.

Further, singular forms that are used in this specification are intended to include plural forms unless the context clearly indicates otherwise. In the specification, terms “configured”, “include”, or the like should not be construed as necessarily including several components or several steps described herein, in which some of the components or steps may not be included or additional components or steps may be further included.

Hereafter, the present invention will be described in more detail through embodiments, but the range of the present invention is not limited to the following examples.

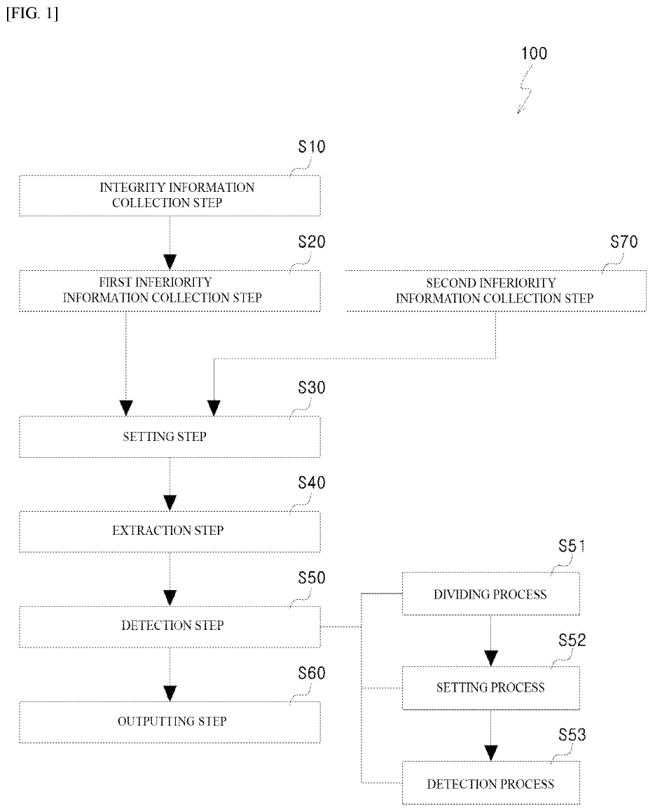

FIG. 1 is a flowchart of a method of detecting an integrity index of a machine tool according to an embodiment of the present invention.

Referring to FIG. 1, a method 100 of detecting an integrity index of a machine tool according to an embodiment of the present invention may include: an integrity information collection step S10, a first inferiority information collection step S20, a setting step S30, an extraction step S40, a detection step S50, and an outputting step S60.

### MODE FOR INVENTION

The integrity information collection step S10 of FIG. 1 is a step of collecting a current amount, which is consumed when a machine tool machines a workpiece in a normal state, in accordance with lapse of time.

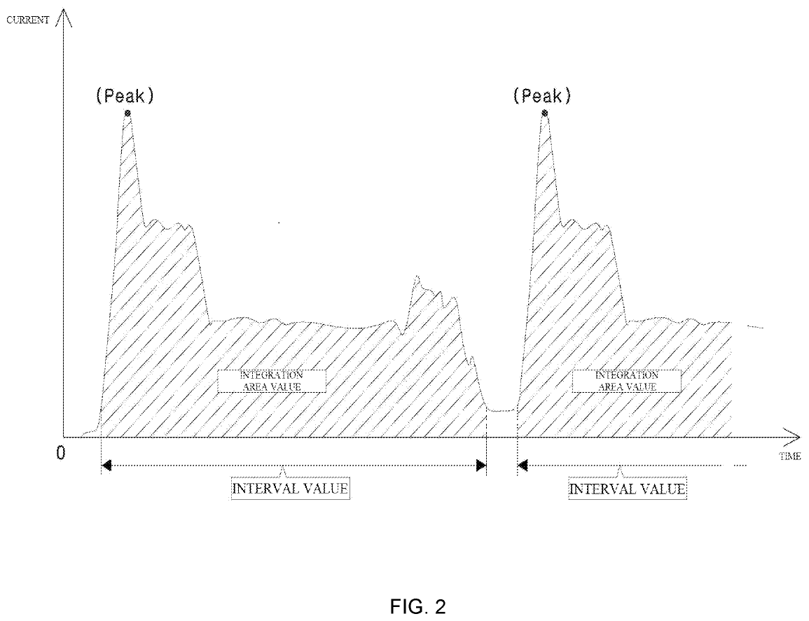

FIG. 2 shows a current amount (power information) according to time in a machine with a machine tool in a normal state.

Referring to FIG. 2, it is possible to extract and collect a peak current value, an integration area value, and a machining interval value of a workpiece from power information.

The collected extraction values (the peak current value, the integration area value, and the interval value) are the base of the integrity reference value that is set to detect the integrity of the machine tool in the setting step S30 to be described below.

The peak current value means a value at which the magnitude of a current value is the peak in the information of power that is consumed by the machine.

The first inferiority information collection step S20 of FIG. 1 is a step of collecting a current amount, which is consumed when a machine tool machines a workpiece in a worn state, in accordance with lapse of time.

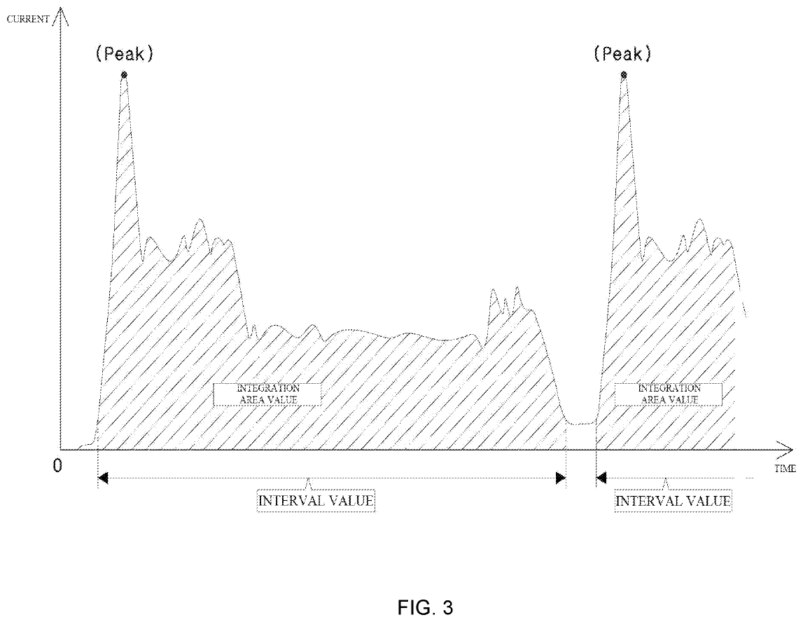

FIG. 3 shows current amount information according to time in a machine with a machine tool in a worn state.

Referring to FIG. 3, it is possible to extract a peak current value, an integration area value, and a machining interval value of a workpiece from power information, respectively.

The extracted extraction values are the base of the inferiority reference value that is set to detect the integrity of the machine tool in the setting step S30.

The setting step S30 of FIG. 1 is a step of setting an integrity reference value and an inferiority reference value on the basis of the information collected in the integrity information collection step S10 and the first inferiority information collection step S20.

That is, the integrity reference value and the inferiority reference value are set by selecting any one of the peak current value, the integration area value, and the interval value collected in the integrity information collection step S10 and the first inferiority information collection step S20, in which the integrity reference value and the inferiority reference value are set by selecting the same kind of values.

The extraction value extracted in the extraction step S40 to be described below is also selected as the same kind of values as the values selected from the integrity reference value and the inferiority reference value such that the integrity of the machine tool is clearly detected through the extraction value.

For example, when the peak current value extracted from machine power information is selected and used as the integrity reference value, the peak current value extracted from the power information of the machine is selected and used as the inferiority reference value and the measurement value.

Meanwhile, the integrity reference value and the inferiority reference value may be set as the average value of the continuously extracted extraction values.

The extraction step S40 of FIG. 1 is a step of collecting the current amount that is consumed when a workpiece is machined through a machine tool in real time in accordance with lapse of time and extracting a measurement value from the collected information.

The extracted measurement value is a value that is used in the detection step S50 to detect the integrity of the machine tool in real time and will be described in detail through the detection step S50.

The detection step S50 of FIG. 1 detects an integrity index value of the machine tool by comparing the measurement value extracted in the extraction step S40 with the integrity reference value and the inferiority reference value set in the setting step S30, and may include a dividing process S51, a setting process S52, and a detection process S53.

The dividing step S51 is a process of dividing the period between the integrity reference value and the inferiority reference value set in the setting step S30 into at least two periods.

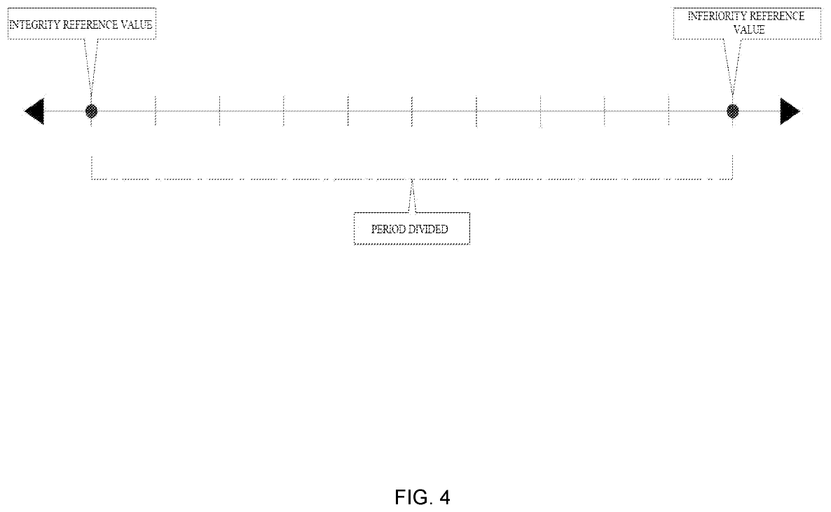

FIG. 4 shows a period divided between an integrity reference value and an inferiority reference value.

Referring to FIG. 4, there are (magnitude) differences between the integrity reference value and the inferiority reference value, a period is formed by the difference between the integrity reference value and the inferiority reference value, and this period is divided into two or more periods at the same interval.

The number of times of dividing between the integrity reference value and the inferiority reference value is determined in accordance with how precise integrity of a machine tool is detected in the detection process S53 to be described below. For example, it is possible to more precisely detect the integrity of a machine tool by dividing the period between the integrity reference value and the inferiority reference value into 100 periods in comparison to dividing the period into 10 periods.

In the method 100 of detecting an integrity index of a machine tool of the present invention, the period between the integrity reference value and the inferiority reference value is divided into 10 periods, but the periods are not limited to the number.

The setting process S52 is a process of constructing an integrity index reference table by setting the periods divided between the integrity reference value and the inferiority reference value as a first period, a second period, . . . , an n-th period sequentially from the integrity reference value and by setting an integrity index value for each of the periods.

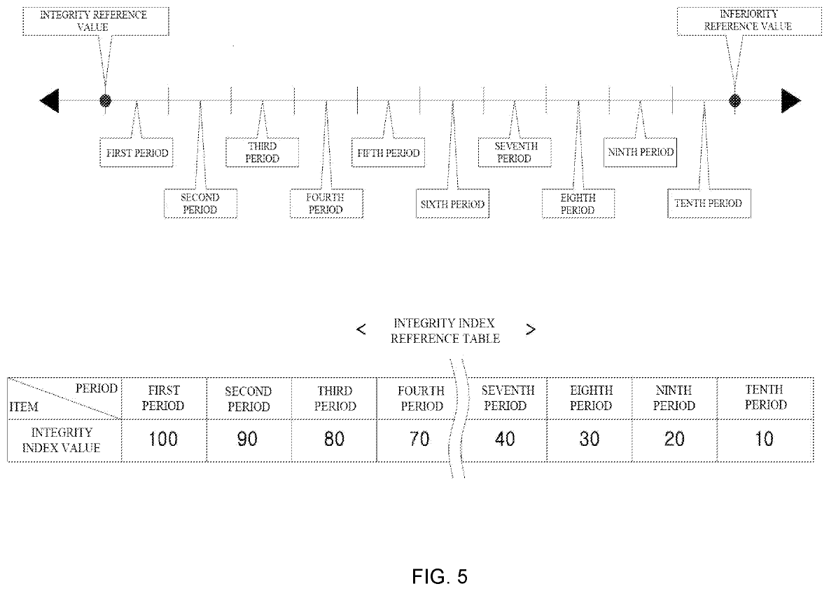

FIG. 5 shows the case in which the period between the integrity reference value and the inferiority reference value are divided into 10 periods.

Referring to FIG. 5, when the period between the integrity reference value and the inferiority reference value is divided into 10 periods in the dividing process, the divided periods are set as a first period, a second period, . . . , and a tenth period from the integrity reference value and then an integrity index value is set for each of the periods, whereby an integrity index reference table is constructed. In the method 100 of detecting an integrity index of a machine tool of the present invention, the integrity index value is limited in the range of a minimum of 10 to a maximum of 100 and the limited integrity index values are applied to periods, respectively, whereby the integrity of the machine tool is detected.

The integrity index value is limited within the range of 10˜100, the state of a machine tool is sound when the integrity index value is large, and the state of the machine tool is poor when the integrity index value is small. However, limiting and setting the range of the integrity index value are arbitrarily determined to describe an example and the integrity index value may be determined in various ranges and settings.

The detection process S53 is a process of detecting a period to which a measurement value corresponds by applying the measurement value extracted in the extraction step S40 to the integrity index reference table, and of detecting the integrity index value of the detected period.

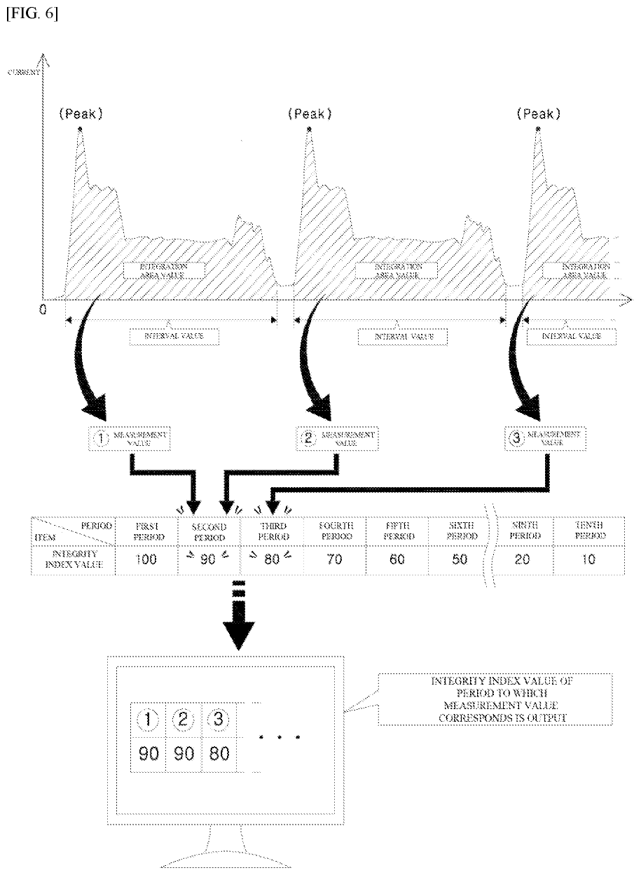

FIG. 6 shows a process of extracting an integrity index value from a measurement value.

Referring to FIG. 6, a measurement value is extracted from the information of power that is consumed when workpieces are continuously machined through a machine in real time, a corresponding period is detected by applying the extracted measurement value to the integrity index reference table, and an integrity index value corresponding to the detected period is extracted (obtained).

The outputting step S60 of FIG. 1 is a step of outputting and providing the integrity index value detected in the detection step S50 to the manager.

That is, when an integrity index value of a machine tool is extracted in real time through the detection step S50, the extracted integrity index value is output as an image through a common monitor, whereby the manager may clearly recognize the integrity state of the machine tool and may effectively cope with the state in accordance with the integrity of the machine tool.

Meanwhile, as shown in FIG. 1, the method may further include a second inferiority information collection step S70 of collecting a current amount that is consumed in accordance with lapse of time when a machine machines a workpiece before a machine tool is broken for each of the inflow period, the constant period, and the outflow period.

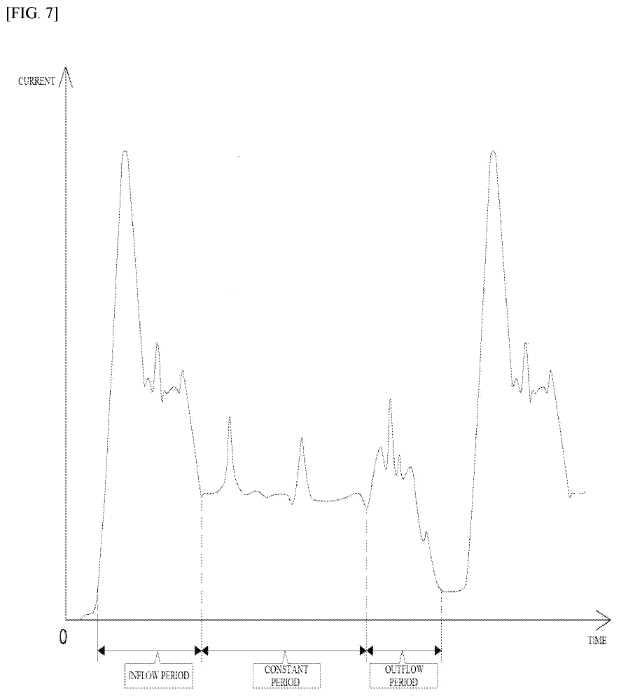

FIG. 7 shows a power consumption amount according to an inflow period, a constant period, and an outflow period.

Referring to FIG. 7, the inflow period is a process in which a machine tool approaches a workpiece, the constant period is a process in which the machine tool machines the workpiece after approaching the workpiece, and the outflow period is a process in which the workpiece finishes being machined, and the machine tool is separated from the workpiece.

That is, it can be seen that a slightly large amount of power is consumed in the inflow period in which a machine tool approaches a workpiece, power consumption is uniformly stabilized and consumed in the constant period, and power less than that of the inflow period but much than that of the constant period is consumed in the outflow period.

In the setting step S30, a warning value and a critical value are set as threshold values in the inflow period, the constant period, and the outflow period on the basis of the information collected in the second inferiority information collection step S70. The warning values and the critical values set in this way are set on the basis of the values at which the current value abnormally changes in each period (inflow, constant, and outflow periods) before the machine tool is broken on the basis of the information collected for a long period of time in the second inferiority information collection step S70.

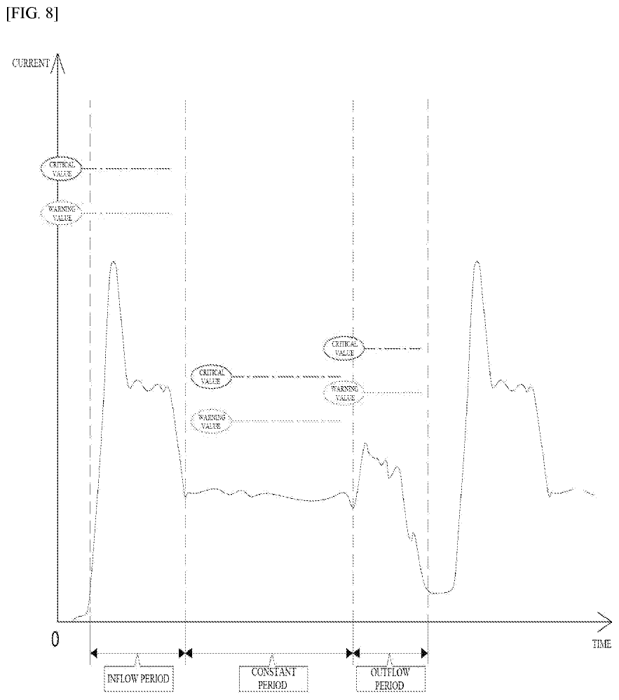

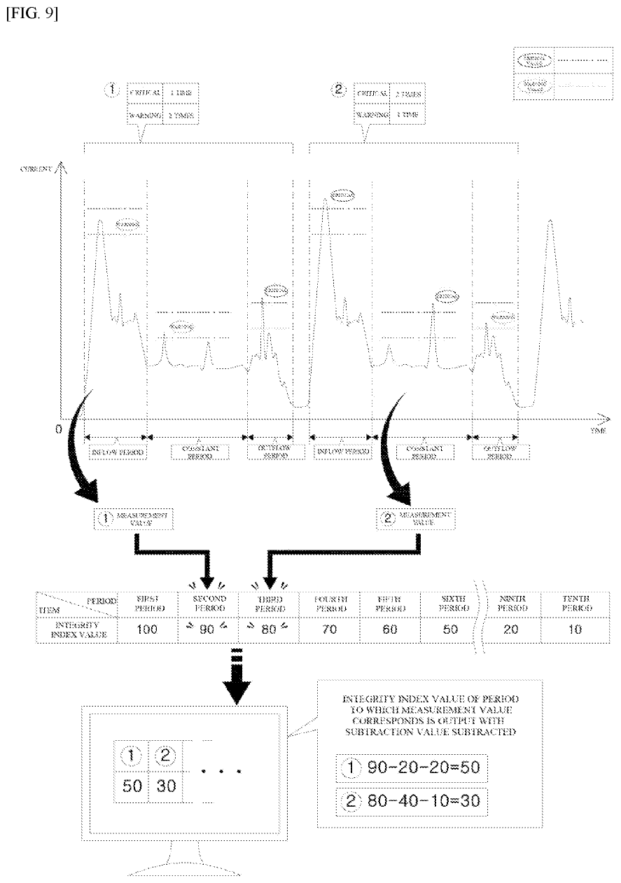

FIG. 8 is a view showing a warning value and a critical value set in each of the inflow period, the constant period, and the outflow period. FIG. 9 shows a process of detecting an integrity index value by applying the information of the number of times of exceeding the warning value and the critical value.

Referring to FIG. 8, the warning value, which is smaller than the critical value, shows a critical state at a lower level than the critical value and may be considered as a degree at which interest and attention are required for the machine tool. The critical value shows a critical state at a higher level than the warning value and may be considered as a degree at which it is required to examine or replace the machine tool.

Thereafter, as shown in FIG. 9, the extraction step S40 may collect in real time the current amount that is consumed when the workpiece is machined by the machine tool for each of the inflow period, the constant period, and the outflow period.

The detection step S50 detects the number of times that the current amount of the inflow period, the constant period, and the outflow period collected in the extraction step S40 exceeds the warning value and the critical value in each of the periods set in the setting step S30 and applies the information of the detected number of times to extract the integrity index value, thereby inducing precise detection of the integrity index of the machine tool.

That is, the detection step S50 sets a subtraction value for each of the warning value and the critical value, applies the measurement value extracted in the extraction step S40 to the integrity index reference table, and subtracts a subtraction value corresponding to the number of times of exceeding the warning value and the critical value from the detected integrity index value, thereby detecting the integrity index value.

For example, the subtraction value for the warning value is set as −10, the subtraction value for the critical value is set as −20, and an integrity index value detected by applying the measurement value extracted in the extraction step S40 to the integrity index reference table is 90, and in this state, when the current amount (current value) of the inflow period, the constant period, and the outflow period collected in the extraction step S40 exceeds the critical value one time and the warning value two tomes, −20 for one critical value is subtracted from 90 and −20 for two warning values is subtracted from 90, whereby the integrity index value becomes 50. In the next machining, when the current amount exceeds the critical value two times and the warning value one time, −40 for two critical values is subtracted from 90 and −10 for one warning value is subtracted from 90, whereby the integrity index value becomes 40.

When the integrity index value of the machine tool is low, the manager may clearly find out the reason, so the manager may induce appropriate and easy measures.

The method 100 of detecting an integrity index of a machine tool of the present invention that detects an integrity index of a machine tool through the process described above: collects the information of power that is consumed by a machine with a machine tool in a normal state and the information of power that is consumed by the machine with the machine tool in a worn state: constructs an integrity index reference table on the basis of the collected information; applies measurement values collected in real time through the machine to the integrity index reference table; and outputs and providing in real time an integrity index value showing the integrity of the machine tool to a manager, thereby enabling the manager to clearly recognize the real-time integrity of a machine tool from an integrity index, to make a plan for examining or replacing the machine tool by himself/herself, and to very actively and stably manage the entire machine tool, and preventing a safety accident or an economic loss due to damage or breakage of the machine tool.

Further, the method: collects a current amount that is consumed by a machine in accordance with lapse of time for each of an inflow period, a constant period, and an outflow period before a machine tool is broken; sets a warning value and a critical value of each period on the basis of the collected information; detects in real time the number of times that the current amount consumed by the machine exceeds the warning value and the critical value of each period; and subtracts a subtraction value corresponding to the detected number of times from an integrity index value, thereby being able to more precisely detect the integrity of the machine tool through the integrity index value.

Although specific preferred embodiments of the present invention were described above, the present invention is not limited to the specific embodiments and may be changed in various ways by those skilled in the art without departing from the spirit of the present invention, and the changes are included in claims.

### INDUSTRIAL APPLICABILITY

The present invention can be used to detect the integrity index of a machine tool.

1. A method of detecting an integrity index of a machine tool, the method comprising:
an integrity information collection step of collecting a current amount, which is consumed when the machine tool machines a workpiece in a normal state, in accordance with lapse of time;
a first inferiority information collection step of collecting a current amount, which is consumed when the machine tool machines the workpiece in a worn state, in accordance with lapse of time;
a setting step of setting an integrity reference value and an inferiority reference value based on the information collected in the integrity information collection step and the first inferiority information collection step;
an extraction step of collecting a current amount that is consumed when the workpiece is machined through the machine tool in real time in accordance with lapse of time, and extracting a measurement value from the collected information;
a detection step of detecting an integrity index value of the machine tool by comparing the measurement value extracted in the extraction step with the integrity reference value and the inferiority reference value set in the setting step; and
an outputting step of outputting the integrity index value detected in the detection step.

2. The method of claim 1, wherein the integrity reference value, the inferiority reference value, and the measurement value are set as any one selected from a peak current value, an integration area value, and a machining interval value of the workpiece that can be extracted from the current amount, which is consumed by a machine when a workpiece is machined, in accordance with lapse of time.

3. The method of claim 1, wherein the detection step further comprising:
a dividing step of dividing a period between the integrity reference value and the inferiority reference value set in the setting step into at least two periods;
a setting step of setting the periods divided between the integrity reference value and the inferiority reference value as a first period, a second period, . . . , an n-th period sequentially from the integrity reference value and constructing an integrity index reference table by setting an integrity index value for each of the periods; and
a detection step of detecting a period to which the measurement value corresponds by applying the measurement value extracted in the extraction step to the integrity index reference table, and of extracting the integrity index value of the detected period.

4. The method of claim 1, further comprising a second inferiority information collection step of collecting a current amount which is consumed in accordance with lapse of time when a machine machines the workpiece before the machine tool is broken for each of an inflow period, a constant period, and an outflow period.

5. The method of claim 4, wherein the setting step comprises setting a warning value and a critical value in each of the inflow period, the constant period, and the outflow period based on the information collected in the second inferiority information collection step;
the extraction step comprises collecting the current amount which is consumed when the workpiece is machined by the machine tool for each of the inflow period, the constant period, and the outflow period; and
the detection step comprises detecting the integrity index value of the machine tool by detecting the number of times that the current amount of the inflow period, the constant period, and the outflow period collected in the extraction step exceeds the warning value and the critical value in each of the inflow period, the constant period, and the outflow period set in the setting step.

6. The method of claim 5, wherein the detection step comprises setting a subtraction value for each of the warning value and the critical value, detecting an integrity index value by applying the measurement value extracted in the extraction step to the integrity index reference table, and subtracting a subtraction value corresponding to the number of times of exceeding the warning value and the critical value from the detected integrity index value.
